(19) United States
(12) Patent Application Publication
(10) Pub. No.: US 2022/0318563 A1
(43) Pub. Date: Oct. 6, 2022

(54) INFORMATION PROCESSING METHOD, INFORMATION PROCESSING APPARATUS, AND PROGRAM

(71) Applicant: SONY GROUP CORPORATION, TOKYO (JP)

(72) Inventor: TAKUYA YASHIMA, TOKYO (US)

(21) Appl. No.: 17/597,585

(22) PCT Filed: Jul. 9, 2020
(86) PCT No.: PCT/JP2020/026866

§ 371 Date: Jan. 12, 2022

(30) Foreign Application Priority Data
Jul. 22, 2019 (JP) 2019-134599

(51) Int. Cl. G06K 9/62; G06N 3/08; G06F 3/0482

(52) U.S. Cl. CPC G06K 9/6253; G06N 3/08; G06F 3/0482

(57) ABSTRACT

The present disclosure relates to an information processing method, an information processing apparatus, and a program that allow a neural network tailored to a desired task to be designed with ease. An information processing apparatus accepts selection of a task by a user, acquires input data used for learning of the task, and displays, as a default model, a neural network having a structure appropriate to the selected task and the acquired input data. The present disclosure is applicable, for example, to a GUI that allows the user to intuitively design a neural network.

### TECHNICAL FIELD

The present disclosure relates to an information processing method, an information processing apparatus, and a program, and particularly to an information processing method, an information processing apparatus, and a program that allow a neural network tailored to a desired task to be designed with ease.

### BACKGROUND ART

There have been known neural networks used for deep learning. In such networks, a variety of techniques for searching for an optimal solution from among a plurality of options have been proposed.

For example, PTL 1 discloses an information processing apparatus that updates an optimal solution of an evaluated neural network on the basis of an evaluation result of another neural network having a different network structure generated from the evaluated neural network. According to an information processing method described in PTL 1, it is possible to search more efficiently for a network structure appropriate to environment.

Also, recent years have seen services available that automatically design a deep learning model for image recognition without designing a neural network used for deep learning (deep learning model) simply if input data and a label are given.

### CITATION LIST

### Patent Literature

### [PTL 1]

PCT Patent Publication No. WO2017-154284

### Technical Problem

There are a number of tasks to which deep learning is applicable including not only image recognition but also a generation model, super resolution, and voice/language processing.

However, neural network design techniques available today are mainly intended for image recognition, and no consideration has been given to designing of a neural network tailored to other tasks.

The present disclosure has been devised in light of the foregoing, and it is an object of the present disclosure to allow a neural network tailored to a desired task to be designed with ease.

### Solution to Problem

An information processing method of the present disclosure is an information processing method including, by an information processing apparatus, accepting selection of a task by a user, acquiring input data used for learning of the task, and displaying, as a default model, a neural network having a structure appropriate to the selected task and the acquired input data.

An information processing apparatus of the present disclosure is an information processing apparatus that includes an acceptance section adapted to accept selection of a task by a user, an acquisition section adapted to acquire input data used for learning of the task, and a display control section adapted to display, as a default model, a neural network having a structure appropriate to the selected task and the acquired input data.

A program of the present disclosure is a program for causing a computer to perform processes of accepting selection of a task by a user, acquiring input data used for learning of the task, and displaying, as a default model, a neural network having a structure appropriate to the selected task and the acquired input data.

In the present disclosure, user selection of a task is accepted, input data used for learning of the task is acquired, and a neural network having a structure appropriate to the selected task and the acquired input data is displayed as a default model.

### BRIEF DESCRIPTION OF DRAWINGS

FIG. 1 is a diagram illustrating a configuration example of an information processing system according to an embodiment of the present disclosure.

FIG. 2 is a block diagram illustrating a configuration example of an information processing apparatus.

FIG. 3 is a block diagram illustrating a functional configuration example of a control section.

FIG. 4 is a diagram illustrating an example of a GUI.

FIG. 5 is a flowchart describing an automatic model structure search process.

FIG. 6 is a flowchart describing the automatic model structure search process.

FIG. 7 is a flowchart describing the automatic model structure search process.

FIG. 8 is a diagram illustrating an example of a GUI.

FIG. 9 is a diagram illustrating an example of a GUI.

FIG. 10 is a diagram illustrating an example of a GUI.

FIG. 11 is a diagram illustrating an example of a GUI.

FIG. 12 is a diagram illustrating examples of parameters that can be set for structure search.

FIG. 13 is a diagram illustrating examples of parameters that can be set for structure search.

FIG. 14 is a diagram illustrating examples of parameters that can be set for structure search.

FIG. 15 is a diagram illustrating an example of a GUI.

FIG. 16 is a diagram illustrating an example of a GUI.

FIG. 17 is a diagram illustrating examples of parameters that can be set for structure search.

FIG. 18 is a diagram illustrating an example of a GUI.

FIG. 19 is a diagram illustrating an example of a GUI.

FIG. 20 is a diagram illustrating an example of a GUI.

FIG. 21 is a flowchart describing a model compression process.

FIG. 22 is a flowchart describing the model compression process.

FIG. 23 is a diagram illustrating an example of a GUI.

FIG. 24 is a diagram illustrating an example of a GUI.

FIG. 25 is a diagram illustrating an example of a GUI.

FIG. 26 is a diagram illustrating an example of a GUI.

FIG. 27 is a block diagram illustrating a hardware configuration example of a computer.

### DESCRIPTION OF EMBODIMENT

A description will be given below of a mode for carrying out the present disclosure (hereinafter referred to as an embodiment). It should be noted that the description will be given in the following order.

1. Configuration of system and apparatus

2. Automatic model structure search

3. Model compression

4. Configuration example of computer

### 1. Configuration of System and Apparatus

### Configuration Example of Information Processing System

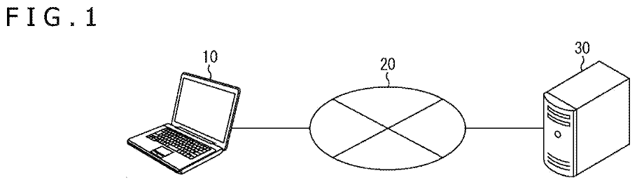

FIG. 1 is a diagram illustrating a configuration example of an information processing system according to the embodiment of the present disclosure.

The information processing system in FIG. 1 includes an information processing terminal 10 and an information processing server 30. The information processing terminal 10 and the information processing server 30 are connected via a network 20 in such a manner as to be able to communicate with each other.

The information processing terminal 10 is an information processing apparatus for presenting a GUI (Graphic User Interface) associated with designing of a neural network to a user. The information processing terminal 10 includes a PC (Personal Computer), a smartphone, a tablet terminal, or the like.

The information processing server 30 is an information processing apparatus that performs a process associated with the designing of a neural network, supplies data required to design the neural network to the information processing terminal 10, or performs other process in response to a request from the information processing terminal 10.

The network 20 has a function to connect the information processing terminal 10 and the information processing server 30. The network 20 includes public line networks such as the Internet, a telephone line network, and a satellite communication network, various LANs (Local Area Networks) including Ethernet (registered trademark) and WANs (Wide Area Networks), and the like. Also, the network 20 may include a leased line network such as an IP-VPN (Internet Protocol-Virtual Private Network).

### Configuration Example of Information Processing Apparatus

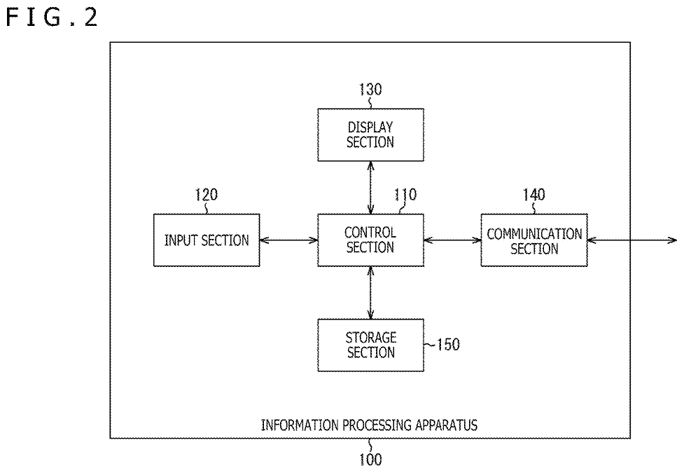

FIG. 2 is a diagram illustrating a configuration example of an information processing apparatus included in the information processing terminal 10 described above.

An information processing apparatus 100 in FIG. 2 includes a control section 110, an input section 120, a display section 130, a communication section 140, and a storage section 150.

The control section 110 includes processors such as a GPU (Graphics Processing Unit) and a CPU (Central Processing Unit) and controls each section of the information processing apparatus 100.

The input section 120 supplies an input signal appropriate to a user's action input to the control section 110. The input section 120 is configured, for example, not only as a keyboard or a mouse but also as a touch panel.

The display section 130 displays a GUI and various pieces of information associated with the designing of a neural network under control of the control section 110.

The communication section 140 supplies, to the control section 110, various pieces of data supplied from the information processing server 30, by communicating with the information processing server 30 via the network 20 under control of the control section 110.

The storage section 150 stores not only various pieces of data used for processes performed by the control section 110 but also programs executed by the control section 110.

### Functional Configuration Example of Control Section

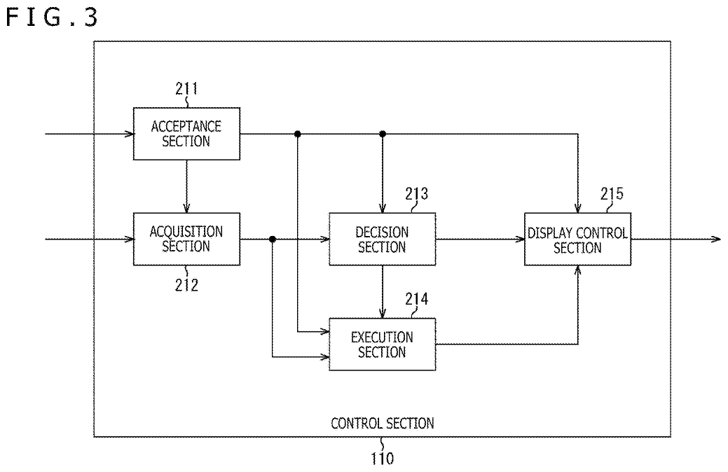

FIG. 3 is a block diagram illustrating a functional configuration example of the control section 110 in FIG. 2.

The control section 110 in FIG. 3 includes an acceptance section 211, an acquisition section 212, a decision section 213, an execution section 214, and a display control section 215. The respective sections of the control section 110 are realized as a result of execution of a given program stored in the storage section 150 by the processor included in the control section 110.

The acceptance section 211 accepts a user's action input on the basis of an input signal from the input section 120. Acceptance information indicating the details of the accepted user's action input is supplied to the respective sections of the control section 110. For example, the acceptance section 211 accepts a user input associated with the designing of a neural network.

The acquisition section 212 acquires data supplied from the information processing server 30 via the communication section 140 and acquires data stored in the storage section 150, according to the acceptance information from the acceptance section 211. Data acquired by the acquisition section 212 is supplied to the decision section 213 and the execution section 214 as appropriate.

The decision section 213 decides a model which will be a candidate neural network presented to the user, according to the acceptance information from the acceptance section 211.

The execution section 214 performs structure search and compression of the model decided by the decision section 213 and performs learning using the model on the basis of the acceptance information from the acceptance section 211 and data from the acquisition section 212.

The display control section 215 controls the display, on the display section 130, of the GUI associated with the designing of a neural network and various pieces of information. For example, the display control section 215 controls the display of a model decided by the decision section 213, information associated with structure search for the model, results of the learning using the model, and the like.

Incidentally, GUIs that allow users to intuitively design a neural network used for deep learning have been known in recent years.

Meanwhile, there are a number of tasks to which deep learning is applicable including not only image recognition but also a generation model, super resolution, and voice/language processing.

However, the GUIs available today are mainly intended for image recognition, and no consideration has been given to designing of a neural network tailored to other tasks.

Accordingly, a description will be given below of an example in which a GUI that allows designing of a neural network tailored to a wide range of tasks is provided.

### 2. Automatic Model Structure Search

A description will be given first of automatic model structure search. Automatic structure search is a technique for automatically searching for a neural network structure used for deep learning and is a technology that finds an optimal network structure from among a number of combinations by using a given algorithm.

Automatic model structure search is initiated, for example, as a result of selection of a menu for performing automatic model structure search by the user in a GUI provided by the information processing apparatus 100.

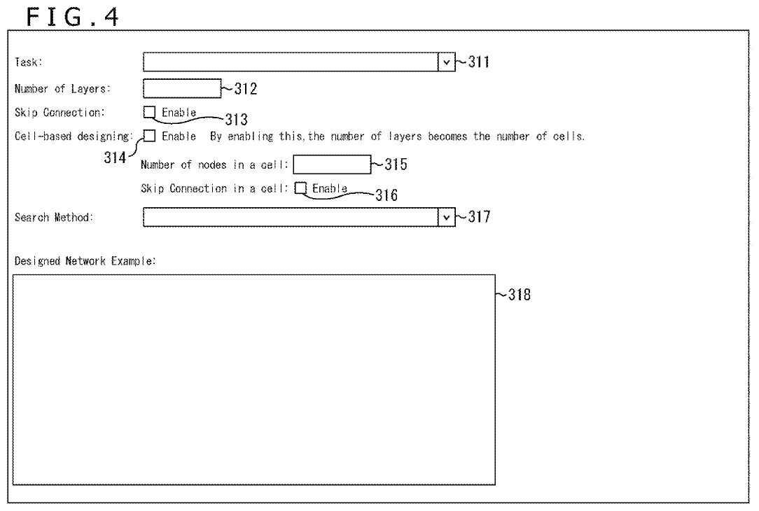

FIG. 4 illustrates an example of a GUI displayed on the display section 130 in a case where a menu for performing automatic model structure search is selected. In the description given below, a screen as illustrated in FIG. 4 will be referred to as an automatic structure search execution screen.

A dropdown list 311, a text box 312, a check box 313, a check box 314, a text box 315, a check box 316, and a dropdown list 317 are provided as various GUI parts on the automatic structure search execution screen. Also, a model display box 318 is provided below the dropdown list 317.

The dropdown list 311 is a GUI part for selecting a task. Here, the term “task” refers to a problem to be tackled by deep learning, such as image recognition, a generation model, super resolution, or voice/language processing.

The text box 312 is a GUI part for inputting the number of computation layers of a neural network subject to structure search.

The check box 313 is a GUI part for selecting whether or not to use skip connection.

The check box 314 is a GUI part for selecting whether or not to perform cell-based structure search. In a case where cell-based structure search is selected as a result of an action performed on the check box 314, the number of computation layers input in the text box 312 represents the number of cells. The plurality of computation layers is included in a cell.

The text box 315 is a GUI part for inputting the number of nodes (computation layers) in a cell.

The check box 316 is a GUI part for selecting whether or not to use skip connection in a cell.

It should be noted that the text box 315 and the check box 316 are activated only in the case where the execution of cell-based structure search is selected in the check box 314.

The dropdown list 317 is a GUI part for selecting a structure search technique.

The model display box 318 is a region where a neural network model subject to structure search or the like is displayed.

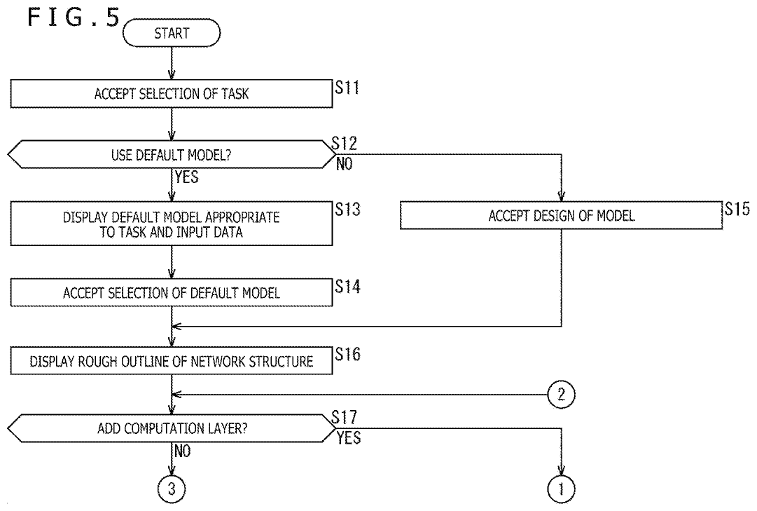

A detailed description will be given below of various GUI parts displayed on the automatic structure search execution screen with reference to a flowchart illustrated in FIGS. 5 to 7.

In step S11, the acceptance section 211 accepts selection of a task made by the user by performing an action on the dropdown list 311.

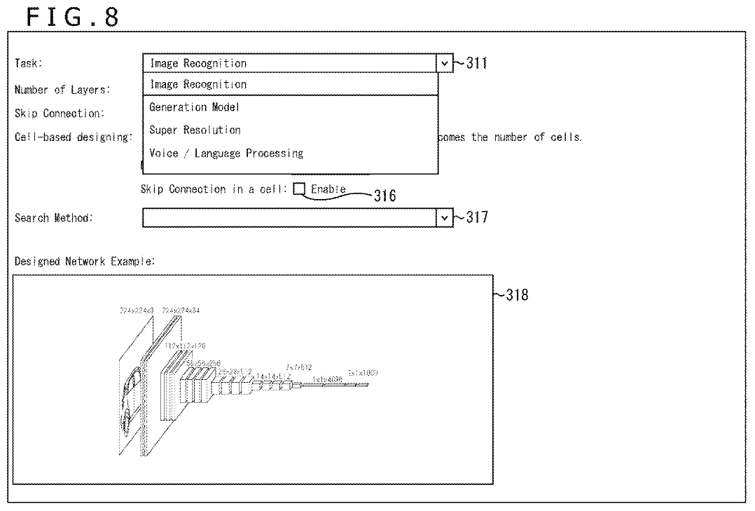

Specifically, four tasks, namely, “Image Recognition,” “Generation Model,” “Super Resolution,” and “Voice/Language Processing” are displayed in the dropdown list 311 as illustrated in FIG. 8, and the user can select any one of the four tasks. In the example illustrated in FIG. 8, “Image Recognition” is selected.

In step S12, it is determined whether or not to use a default model. The default model is a model having a network structure made ready in advance that is tailored to the tasks selectable in the dropdown list 311.

In a case where it is determined in step S12 that a default model will be used, the process proceeds to step S13.

In step S13, the decision section 213 decides, as a default model, a neural network having a structure appropriate to the task selected in the dropdown list 311 and input data acquired at a given timing by the acquisition section 212. Then, the display control section 215 displays the decided default model in the model display box 318.

Input data may be data made ready in advance by the user or data supplied from the information processing server 30.

At this time, a neural network having a structure appropriate to not only the selected task and the acquired input data but also hardware information of the information processing apparatus 100 may be decided and displayed as a default model. The term “hardware information” here includes information associated with processing capabilities of the processors included in the control section 110 of the information processing apparatus 100 and information associated with the number of processors.

In the example in FIG. 8, “Image Recognition” is selected in the dropdown list 311. Accordingly, a feature extractor (encoder) for extracting a feature quantity of an image is displayed, as a default model appropriate to “Image Recognition,” in the model display box 318.

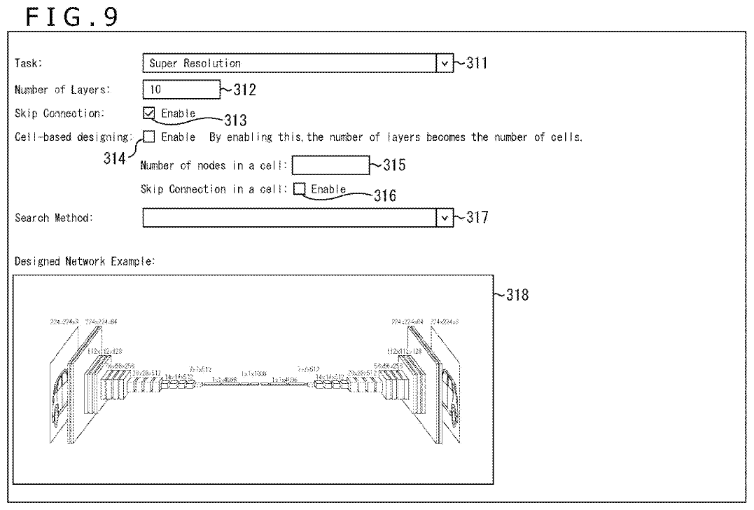

Also, in a case where “Super Resolution” is selected in the dropdown list 311 as illustrated in FIG. 9, an encoder and a decoder included in an auto encoder are displayed, as a default model appropriate to “Super Resolution,” in the model display box 318.

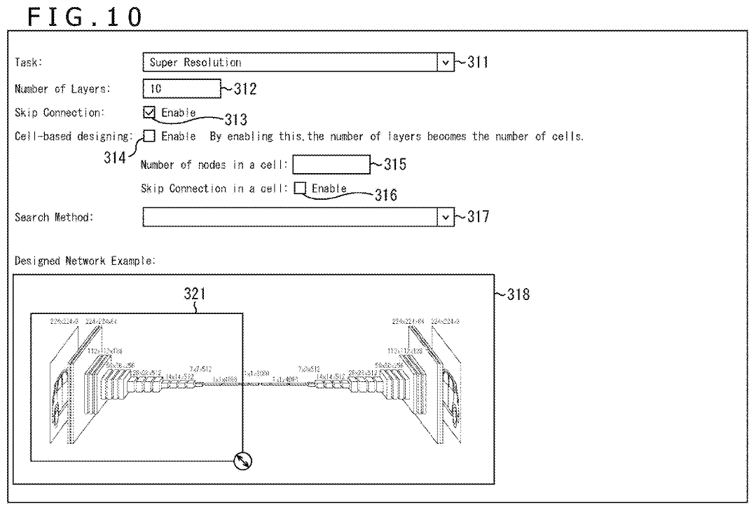

It should be noted that it is possible to use, as layers subject to structure search which will be described later, only some of the computation layers of the default model displayed in the model display box 318. For example, if a given area is specified by a dragging action of the user in the model display box 318, a bounding box 321 is displayed in the model display box 318 as illustrated in FIG. 10. In this case, only the computation layers of the default model surrounded by the bounding box 321 are subject to structure search.

Further, although not illustrated, in a case where “Generation Model” is selected in the dropdown list 311, a decoder is displayed, as a default model appropriate to “Generation Model,” in the model display box 318. Also, in a case where “Voice/Language Processing” is selected in the dropdown list 311, a model having a recursive neural network (RNN) structure is displayed, as a default model appropriate to “Voice/Language Processing,” in the model display box 318.

Here, the number of default models displayed in the model display box 318 is not limited to one, and the acceptance section 211 accepts a change of the displayed default model to other default model in response to a user's action. This allows candidate models subject to structure search to be switched and displayed in the model display box 318.

In step S14, the acceptance section 211 accepts a user's selection of a default model. This allows the default model subject to structure search to be confirmed.

On the other hand, in a case where it is determined in step S12 that a default model will not be used, the process proceeds to step S15, and the acceptance section 211 accepts a user's model design. The model designed by the user is displayed in the model display box 318 as with a default model.

After a default model is confirmed in step S14 or after a model is designed in step S15, the process proceeds to step S16.

In step S16, the display control section 215 displays, together with the model displayed in the model display box 318, a rough outline of the network structure of the model. Specifically, the display control section 215 displays, as a rough outline of the network structure, a search space size and an approximate calculation amount of the model displayed in the model display box 318.

Thereafter, it is determined in step S17 whether or not to add a computation layer to the model displayed in the model display box 318 in response to a user's action. That is, the acceptance section 211 determines whether or not to accept addition of a computation layer to a default model.

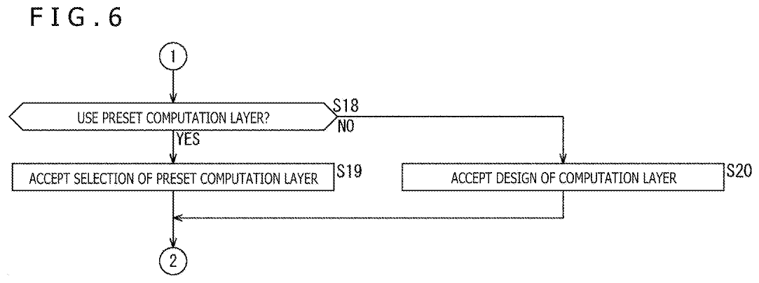

In a case where it is determined in step S17 that a computation layer will be added, the process proceeds to step S18 in FIG. 6, and it is determined whether or not to use a preset computation layer.

In a case where it is determined in step S18 that a preset computation layer will be used, the acceptance section 211 accepts, in step S19, a user's selection of a preset computation layer, and the process returns to step S17.

On the other hand, in a case where it is determined in step S18 that a preset computation layer will not be used, the acceptance section 211 accepts, in step S20, a user's design of a computation layer, and the process returns to step S17.

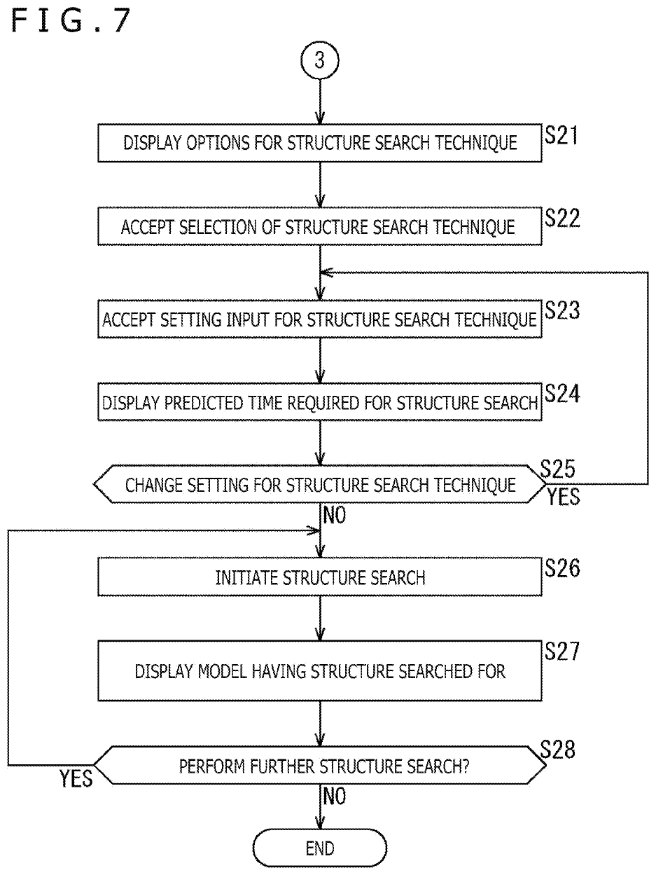

Now, if it is determined in step S17 that a computation layer will not be added, the process proceeds to step S21 in FIG. 7.

In step S21, the display control section 215 displays options for the structure search technique in the dropdown list 317, according to the model displayed in the model display box 318. Specifically, the display control section 215 preferentially displays, in the dropdown list 317, a structure search technique appropriate to the task selected in the dropdown list 311 and the input data acquired at a given timing by the acquisition section 212.

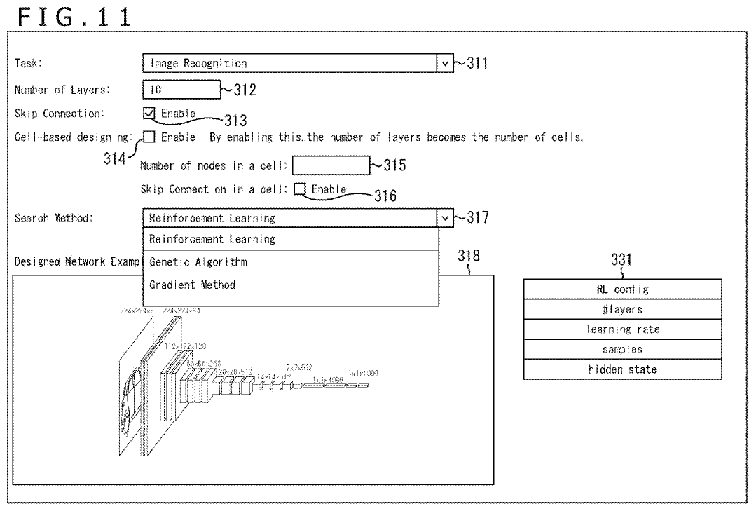

For example, as illustrated in FIG. 11, typical structure search techniques such as “Reinforcement Learning,” “Genetic Algorithm,” and “Gradient Method” are displayed in the dropdown list 317, and the user can select any one of these structure search techniques.

For structure search by reinforcement learning, NASNet proposed in “B. Zoph, V. Vasudevan, J. Shlens, and Q. V. Le. Learning transferable architectures for scalable image recognition. In CVPR, 2018,” ENAS proposed in “H. Pham, M. Y. Guan, B. Zoph, Q. V. Le, and J. Dean. Efficient neural architecture search via parameter sharing. In ICML, 2018,” and other techniques are used, for example. For structure search by the genetic algorithm, AmoebaNet proposed in “E. Real, A. Aggarwal, Y. Huang, and Q. V. Le. Regularized evolution for image classifier architecture search. In AAAI, 2019” and other techniques are used, for example. Also, for structure search by the gradient method, DARTS proposed in “H. Liu, K. Simonyan, and Y. Yang. DARTS: Differentiable architecture search. In ICLR, 2019,” SNAS proposed in “S. Xie, H. Zheng, C. Liu, and L. Lin. SNAS: Stochastic neural architecture search. In ICLR, 2019,” and other techniques are used, for example.

At this time, structure search techniques appropriate to not only the selected task and the acquired input data but also hardware information of the information processing apparatus 100 may be preferentially displayed in the dropdown list 317.

In step S22, the acceptance section 211 accepts selection of a structure search technique made by a user's action on the dropdown list 317. In the example in FIG. 11, “Reinforcement Learning” is selected.

Thereafter, in step S23, the acceptance section 211 accepts a setting input of the structure search technique selected in the dropdown list 317. At this time, for example, a setting entry section 331 for inputting a setting for the structure search technique is displayed on the right of the model display box 318 as illustrated in FIG. 11. Parameters that can be set for the structure search technique selected in the dropdown list 317 are input in the setting entry section 331 by the user.

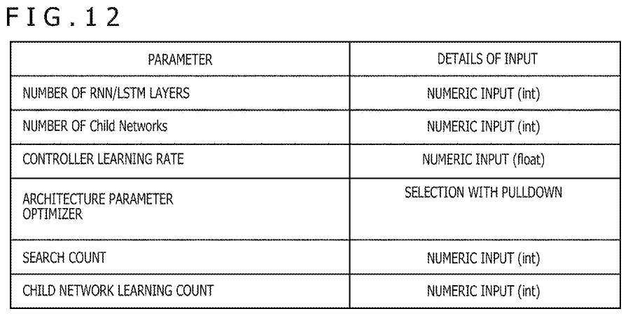

A description will be given here of examples of parameters that can be set for a structure search technique with reference to FIGS. 12 to 14.

FIG. 12 illustrates examples of parameters that can be set for structure search by reinforcement learning.

Parameters that can be set for structure search by reinforcement learning include the number of RNN/LSTM layers, the number of child networks, a controller learning rate, an architecture parameter optimizer, a search count, and a child network learning count.

The number of RNN/LSTM layers is the number of computation layers of an RNN used for reinforcement learning or an LSTM (Long-short Term Memory), the LSTM being a kind of the RNN, and is set by inputting an int type number.

The number of child networks is the number of child networks (candidate networks) output at once from a controller which will be a parent network for predicting a main network structure and is set by inputting an int type number.

The controller learning rate is a parameter associated with learning performed by the above controller and is set by inputting a float type number.

The architecture parameter optimizer is a learning rate adjustment technique and is set by selection with a pulldown (dropdown list). “Adam,” “SGD,” “Momentum,” and the like are made ready as options.

The search count is the number of searches performed and is set by inputting an int type number.

The child network learning count is the number of epochs of the child network per search (number of times a piece of training data is learned repeatedly) and is set by inputting an int type number.

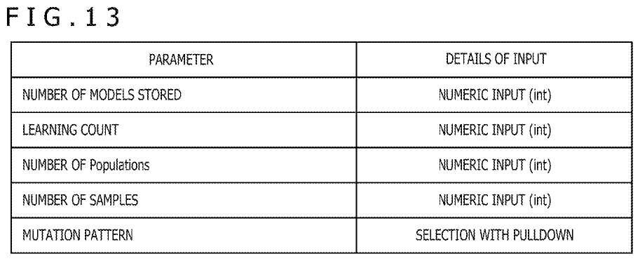

FIG. 13 illustrates examples of parameters that can be set for structure search by evolutionary computation including the genetic algorithm.

Parameters that can be set for structure search by evolutionary computation for performing learning using a plurality of candidate networks include the number of models stored, a learning count, the number of populations, the number of samples, and a mutation pattern.

The number of models stored is the number of generated candidate networks (models) to be stored and is set by inputting an int type number. The number of models stored is approximately equal to the search count.

The learning count is the number of epochs of the generated model and is set by inputting an int type number.

The number of populations is a population size and is set by inputting an int type number.

The number of samples is the number of models sampled from a current population when a mutation model is selected, and is set by inputting an int type number.

The mutation pattern is a pattern of mutation and is set by selection with a pulldown (dropdown list). “Computation and Input Node,” “Computation Only,” “Input Node Only,” and the like are made ready as options.

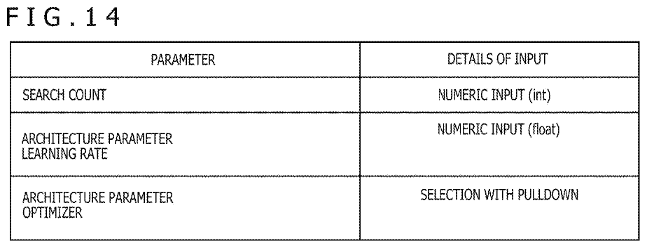

FIG. 14 illustrates examples of parameters that can be set for structure search by the gradient method.

Parameters that can be set for structure search by the gradient method include the search count, the architecture parameter learning rate, and the architecture parameter optimizer.

The search count is the number of epochs of the generated model as with the learning count and is set by inputting an int type number.

The architecture parameter learning rate is a parameter associated with learning performed by the generated model and is set by inputting a float type number.

The architecture parameter optimizer is a learning rate adjustment technique and is set by selection with a pulldown (dropdown list). “Adam,” “SGD,” “Momentum,” and the like are made ready as options.

The parameters as described above can be set in the setting entry section 331, according to a selected structure search technique.

Referring back to the flowchart in FIG. 7, when a setting for the structure search technique is input, the display control section 215 displays, in step S24, a predicted time required for structure search with the set parameters, for example, at a given position in the model display box 318, according to a selected structure search technique.

Thereafter, it is determined in step S25 whether or not to change the setting for the structure search technique.

In a case where it is determined in step S25 that the setting for the structure search technique will be changed, the process returns to step S23, and the processes in steps S23 and S24 are repeated.

On the other hand, in a case where it is determined in step S25 that the setting for the structure search technique will not be changed, the process proceeds to step S26.

In step S26, the execution section 214 initiates structure search with the set parameters.

When the execution of the structure search ends, the display control section 215 displays, in step S27, a model having a structure searched for in the model display box 318.

Thereafter, it is determined in step S28 whether or not to perform further structure search.

In a case where it is determined in step S28 that further structure search will be performed, the process returns to step S26, and the processes in steps S26 and S27 are repeated.

On the other hand, in a case where it is determined in step S28 that further structure search will not be performed, the process is terminated.

According to the above processes, it becomes possible to select tasks such as not only image recognition but also a generation model, super resolution, and voice/language processing, and a neural network having a structure appropriate to a selected task and acquired input data is displayed as a default model. Further, it becomes possible to select various structure search techniques proposed in recent years, and structure search is performed by a selected structure search technique.

This makes it possible to design a neural network tailored to a desired task with ease and, by extension, makes it possible to optimize the structure of a neural network tailored to a wide range of tasks.

### Example of Cell-Based Structure Search

Although a description has been given above of an example of a GUI in a case where cell-based structure search is not performed, a description will be given below of an example of a GUI in a case where cell-based structure search is performed.

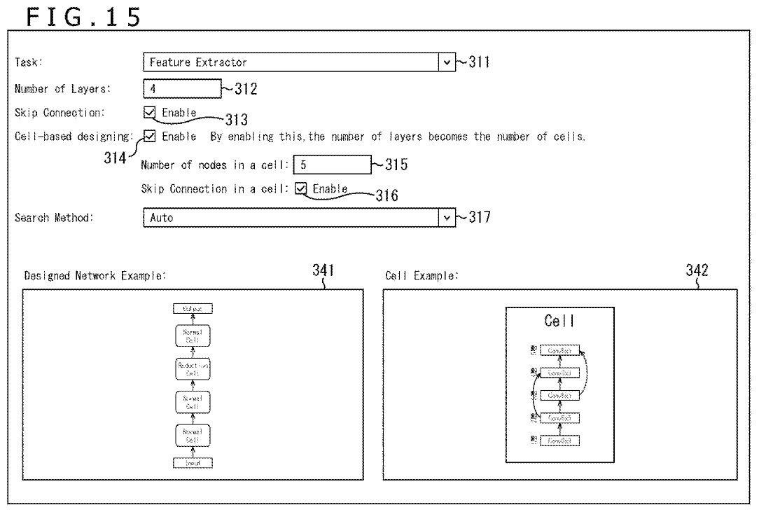

FIG. 15 illustrates an example of a GUI in the case where cell-based structure search is performed.

In the automatic structure search execution screen in FIG. 15, the execution of cell-based structure search is selected as a result of an action performed on the check box 314.

Also, a model display box 341 and a cell display box 342 are provided on the automatic structure search execution screen in FIG. 15 instead of the model display box 318 on the automatic structure search execution screen described above.

The model display box 341 is a region where a neural network model subject to structure search as a whole is displayed. The model displayed in the model display box 341 is a cell accumulation model that includes a plurality of cells (cell blocks).

Also, the model display box 341 displays, as a rough outline of the network structure, a search space size and an approximate calculation amount of the model displayed in the model display box 341, together with the model that includes the plurality of cells.

The cell display box 342 is a region where a cell subject to structure search is displayed, the cell being included in the model displayed in the model display box 341. The cell displayed in the cell display box 342 includes a plurality of computation layers.

In the automatic structure search execution screen in FIG. 15, a rough estimate of a worst calculation amount or the like may be displayed to allow the user to specify a permissible calculation amount. This makes it possible to perform structure search in consideration of a restriction on the calculation amount.

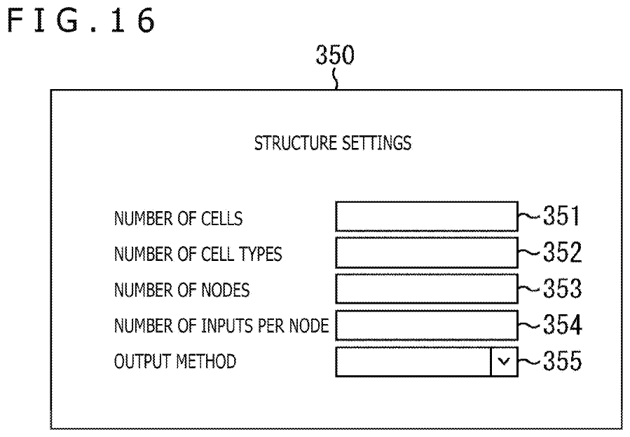

FIG. 16 illustrates an example of a setting screen used to set a model structure displayed in the model display box 341 and a cell structure displayed in the cell display box 342. A setting screen 350 in FIG. 16 pops up on the automatic structure search execution screen, for example, as a result of a clicking action performed on a given region of the model display box 341 or the cell display box 342.

Text boxes 351, 352, 353, and 354 and a dropdown list 355 are provided on the setting screen 350.

The text box 351 is a GUI part for inputting the number of cells included in the model displayed in the model display box 341.

The text box 352 is a GUI part for inputting the number of cell types included in the model displayed in the model display box 341.

The text box 353 is a GUI part for inputting the number of nodes (computation layers) in the cell displayed in the cell display box 342.

The text box 354 is a GUI part for inputting the number of inputs per node in the cell displayed in the cell display box 342.

The dropdown list 355 is a GUI part for selecting a reduction computation technique at an output node. For example, three reduction computation techniques, namely, “element-wise add,” “concatenate,” and “average” are displayed in the dropdown list 355, and the user can select any one of the three reduction computation techniques.

The details of settings specified in such a manner are reflected in real time on the model displayed in the model display box 341 and the cell displayed in the cell display box 342.

It should be noted that, depending on the settings in the setting screen 350, it is also possible to build not only a cell accumulation model but also a multi-layered feedforward neural network. Although not illustrated, it is possible to build, for example, a model whose number of cells is one, whose number of nodes in the cell is eight, and whose number of inputs per node in the cell is one.

Also, although it has been described that parameters for structure search are set according to a selected structure search technique, it is also possible to set parameters that are independent of a structure search technique.

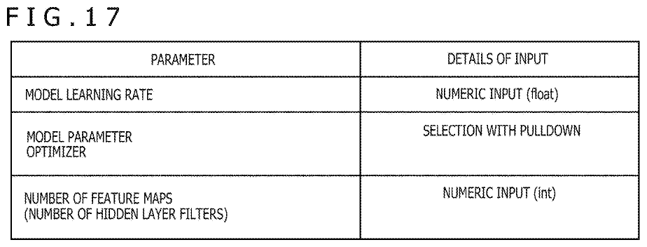

FIG. 17 illustrates examples of parameters that are independent of a selected structure search technique and that can be set for general structure search.

Parameters that can be set for general structure search include a model learning rate, a model parameter optimizer, and the number of feature maps.

The model learning rate is a parameter associated with learning performed by a model subject to structure search and is set by inputting a float type number.

The model parameter optimizer is a model learning rate adjustment technique and is set by selection with a pulldown (dropdown list). “Adam,” “SGD,” “Momentum,” and the like are made ready as options.

The number of feature maps is the number of hidden layer filters in a first cell of a built model and is set by inputting an int type number.

Such parameters can be set regardless of a selected structure search technique.

### Definition of Search Space

The user can select a computation layer to be used for structure search from among preset computation layers.

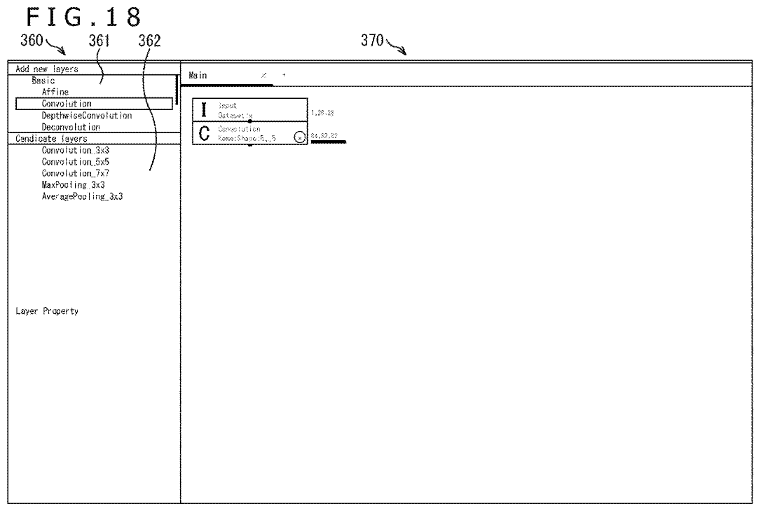

FIG. 18 illustrates an example of a screen displayed when the user selects a computation layer to be used for structure search from among preset computation layers.

A selection section 361 is provided at an upper edge of a region 360 of the screen in FIG. 18. Types of computation layers are displayed, as options, in the selection section 361. In the example in FIG. 18, “Affine,” “Convolution,” “DepthwiseConvolution,” and “Deconvolution” are displayed as options, and “Convolution” is selected.

A selection section 362 is provided below the selection section 361. In the selection section 362, computation layers preset as the type selected in the selection section 361 are displayed as options. In the example in FIG. 18, “Convolution_3×3,” “Convolution_5×5,” “Convolution_7×7,” “MaxPooling_3×3,” and “AveragePooling_3×3” are displayed as options.

A model that includes the computation layer selected from among the preset computation layers is displayed in a region 370 of the screen in FIG. 18. A model that includes an input layer and a convolution layer is displayed in the example in FIG. 18.

Further, the user can uniquely define a computation layer to be used for structure search.

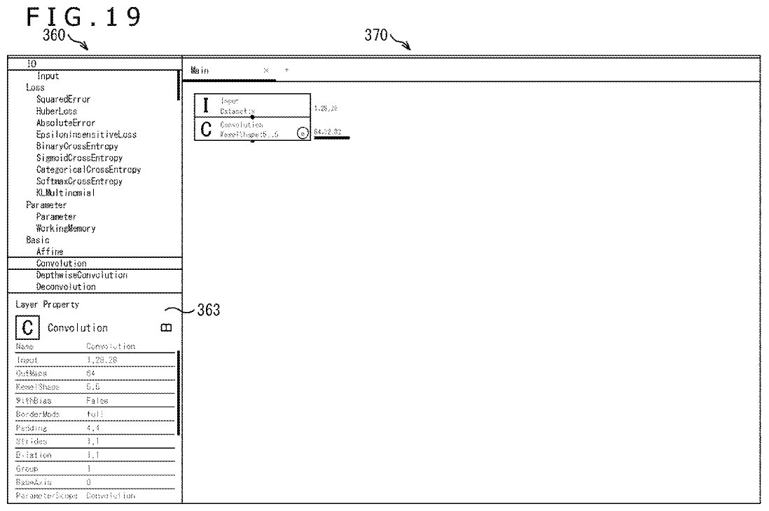

FIG. 19 illustrates an example of a screen displayed when the user uniquely defines a computation layer to be used for structure search.

A setting section 363 is provided at a lower part of the region 360 of the screen in FIG. 19. The setting section 363 is displayed, for example, as a result of pressing of a computation addition button which is not illustrated. Various parameters for the computation layer selected by the user are displayed in the setting section 363.

The user can uniquely define a computation layer to be used for structure search by setting desired values as parameters for the computation layer in the setting section 363.

It should be noted that it is necessary to ensure that input and output sizes remain unchanged by computations in the cell in structure search for a cell accumulation model. Accordingly, parameters that can be set by the user in the setting section 363 may be restricted to some of the parameters, and then other parameters may be set automatically according to the settings of those some of the parameters. For example, as for the parameters of the convolution layer, parameters other than filter size are automatically set by setting the filter size.

### (Structure Search Execution Result)

When the execution of structure search ends as described above, the network having a structure searched for is displayed.

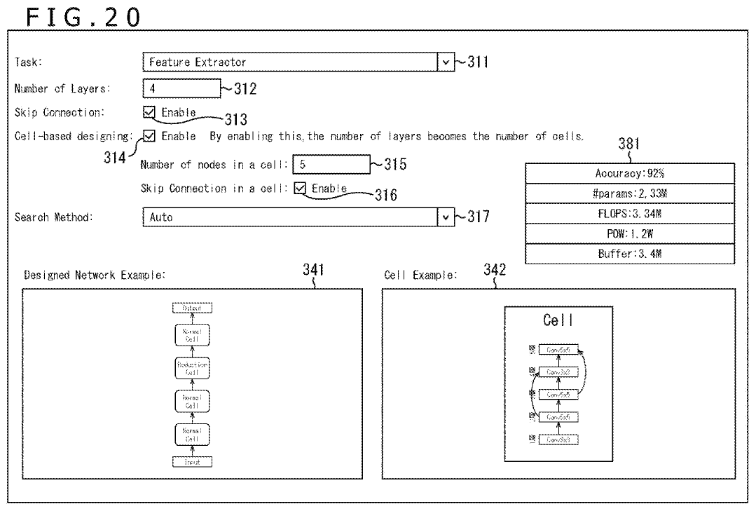

FIG. 20 illustrates an example of a screen in which a structure search execution result for the cell accumulation model described above is displayed.

In the example in FIG. 20, the model and the cell having a structure searched for are displayed in the model display box 341 and the cell display box 342.

Further, accuracy, the calculation amount, and the like may be displayed in addition to the model and the cell having a structure searched for. In the example in FIG. 20, an accuracy/calculation amount display section 381 is provided above the cell display box 342. The accuracy, the number of parameters (size), FLOPS (Floating-point Operations per Second), power consumption, and an intermediate buffer (size) are displayed in the accuracy/calculation amount display section 381.

The user can determine whether or not to perform structure search again by confirming the accuracy, the calculation amount, and the like displayed in the accuracy/calculation amount display section 381.

In particular, no consideration has been given to restrictions on the calculation amount of hardware that performs structure search in GUIs associated with the existing neural network design.

In contrast, according to the configuration described above, it is possible to realize structure search that takes into consideration a restriction on the calculation amount through a simple action.

### <3. Model Compression>

A description will be given next of model compression. Model compression is a technique for reducing a calculation cost by simplifying a structure in a neural network, and as an example, distillation that realizes performance of a large-scale complicated network with a small-size network and the like are known.

Model compression is initiated, for example, as a result of selection of a menu for performing model compression by the user in a GUI provided by the information processing apparatus 100. Also, model compression may be initiated as a result of selection of a button or the like for performing model compression in a screen on which a structure search execution result is displayed as illustrated in FIG. 20.

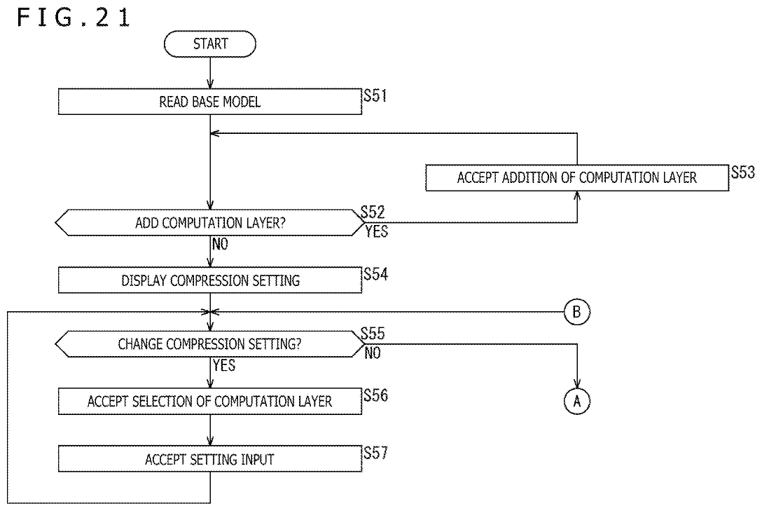

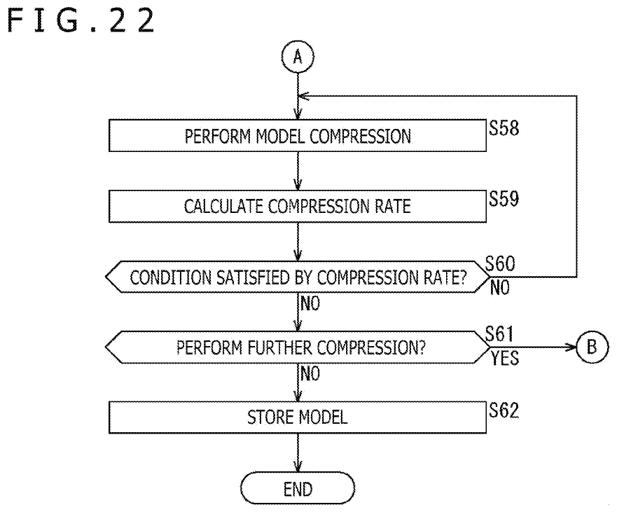

FIGS. 21 and 22 depict a flowchart describing a model compression process.

In step S51, the acquisition section 212 reads a base model that is a model subject to compression. The base model may be a model designed in advance or a model after execution of the above structure search.

In step S52, it is determined whether or not to add a computation layer to the read model.

In a case where it is determined that a computation layer is added to the base model, the process proceeds to step S53, and the acceptance section 211 accepts addition of a computation layer to the base model.

Steps S52 and S53 are repeated until it is determined that a computation layer will not be added to the base model, and when it is determined that a computation layer will not be added to the base model, the process proceeds to step S54.

In step S54, the display control section 215 displays a current compression setting.

Thereafter, it is determined in step S55 whether or not to change the compression setting in response to a user action.

In a case where it is determined in step S55 that the compression setting will be changed, the process proceeds to step S56, and the acceptance section 211 accepts selection of a computation layer. At this time, the acceptance section 211 accepts selection of a base model compression technique.

Next, in step S57, the acceptance section 211 accepts a compression setting input of the selected computation layer. At this time, a condition for compressing the selected computation layer is input as a compression setting. After step S57, the process returns to step S55.

A compression setting for the selected computation layer is decided in such a manner.

On the other hand, in a case where it is determined in step S55 that the compression setting will not be changed, the process proceeds to step S58 in FIG. 22.

In step S58, the execution section 214 performs model compression on the basis of the compression setting specified for each of the computation layers.

In step S59, the execution section 214 calculates the compression rate of each computation layer. At this time, the display control section 215 displays the compression rate of each computation layer as a compression result.

In step S60, the execution section 214 determines whether or not the calculated compression rate of each computation layer satisfies the compression condition set for each computation layer.

In a case where it is determined that the compression rate does not satisfy the condition, the process returns to step S58, and the execution of the model compression and the calculation of the compression rate are repeated.

On the other hand, in a case where it is determined that the compression rate satisfies the condition, the process proceeds to step S61.

In step S61, it is determined whether or not to perform further compression for the base model in response to a user action.

In a case where it is determined that further compression will be performed, the process returns to step S55 in FIG. 21, and subsequent processes are repeated.

On the other hand, in a case where it is determined in step S61 that further compression will not be performed, the process proceeds to step S62, and the execution section 214 stores the compressed model and terminates the process.

### Examples of GUIs

A description will be given below of examples of GUIs displayed in the display section 130 in the model compression process.

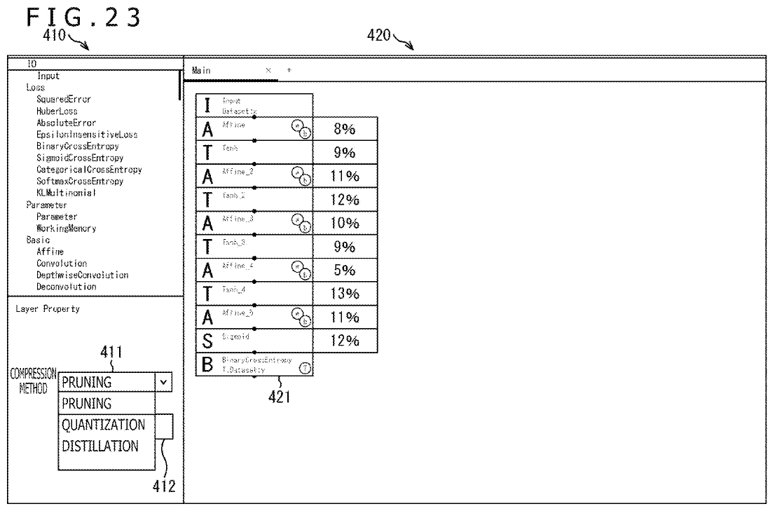

FIG. 23 illustrates an example of a screen where settings associated with model compression are specified.

A dropdown list 411 and a button 412 are provided at a lower part of a region 410 of the screen in FIG. 23. The dropdown list 411 is a GUI part for selecting a compression technique.

Three compression techniques, namely, “Pruning,” “Quantization,” and “Distillation” are displayed in the dropdown list 411, and the user can select any one of the three compression techniques.

The button 412 is a GUI part for performing compression by the compression technique selected in the dropdown list 411.

In a region 420 of the screen in FIG. 23, a base model 421 subject to compression is displayed. A calculation amount for each computation layer included in the base model 421 is indicated on the right of the base model 421. The calculation amount for each computation layer is indicated as a ratio of memory usage by each computation layer when the entire memory usage is assumed to be 100%.

The user can find out which computation layer can be a bottleneck in the base model 421 by confirming the calculation amount for each computation layer included in the base model 421.

Also, as for compression using the compression technique selected in the dropdown list 411, an accuracy deterioration tolerance value which is an index of the extent to which accuracy deterioration is tolerated and a target compression rate may be set by the user.

In the example in FIG. 23, it is possible to render all computation layers included in the base model 421 or only some of the computation layers subject to compression.

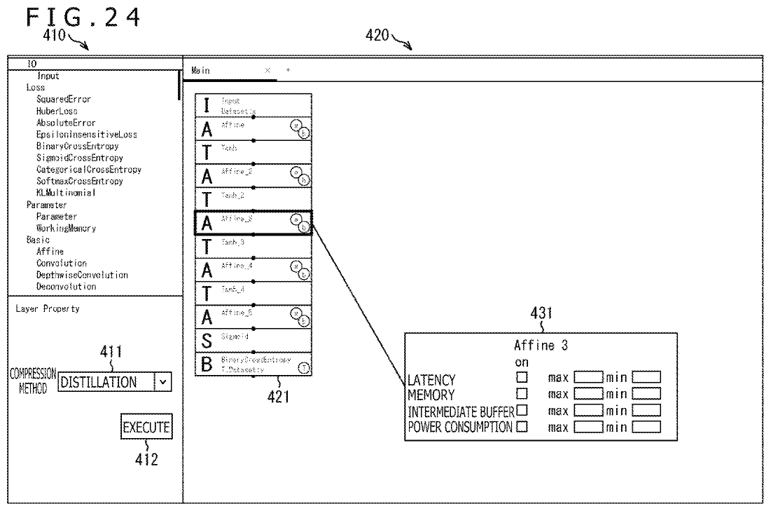

FIG. 24 illustrates an example in which a compression setting is specified for each computation layer included in the base model 421.

In FIG. 24, from among the computation layers included in the base model 421, an “Affine_3” layer is selected, and a child screen 431 is displayed. The child screen 431 is a screen for setting a permissible range (compression condition) for each of indices, namely, latency, the memory, the intermediate buffer, and the power consumption, for the selected computation layer.

A radio button for enabling a setting of a permissible range for each of the indices and text boxes for inputting a minimum value and a maximum value of the permissible range are provided in the child screen 431. A compression condition associated with the selected computation layer is set by enabling the setting of the permissible range and inputting the minimum and maximum values of the permissible range.

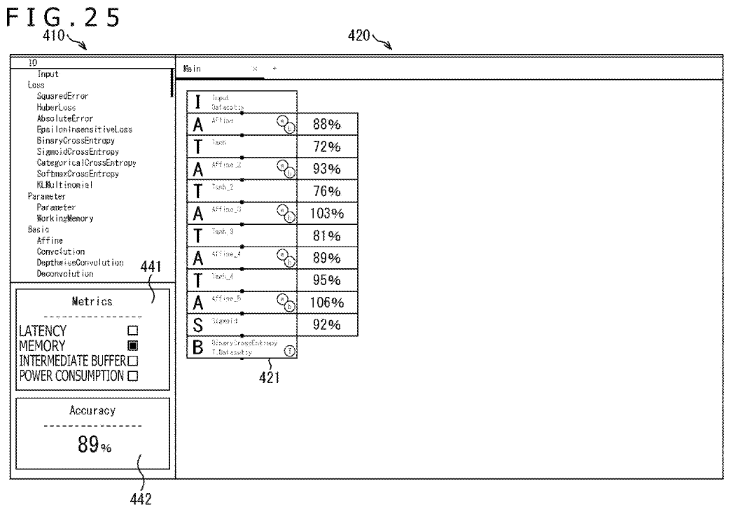

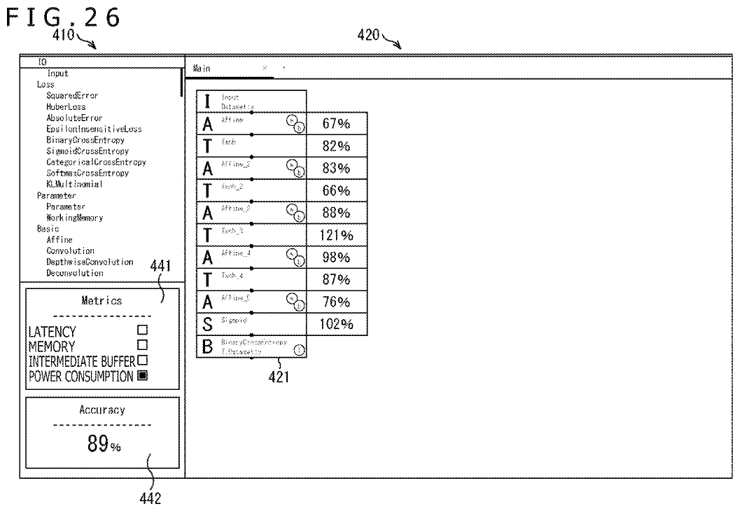

FIGS. 25 and 26 illustrate examples of screens on which compression results are displayed.

An index selection section 441 for selecting for which index a compression result is displayed and an accuracy change rate display section 442 for displaying an accuracy change rate resulting from compression are provided at a lower part of the region 410 of each of the screens in FIGS. 25 and 26.

A compression result for each computation layer included in the base model 421 is indicated on the right of the base model 421 subject to compression in the region 420 of each of the screens in FIGS. 25 and 26. A compression rate for the index selected in the index selection section 441 is indicated as a compression result for each computation layer.

Specifically, in the example in FIG. 25, the memory is selected in the index selection section 441, and a compression rate for the memory is indicated as a compression result for each computation layer included in the base model 421.

Also, in the example in FIG. 26, the power consumption is selected in the index selection section 441, and a compression rate for the power consumption is indicated as a compression result for each computation layer included in the base model 421.

This makes it possible for the user to determine which computation layer will be subject to further compression.

According to the above process, it is possible to perform compression on not only the model for which structure search has been performed but also on existing models, thus allowing for reduction in calculation cost.

It has been described above that processes and GUI display associated with automatic model structure search and model compression are performed on the information processing terminal 10 configured as the information processing apparatus 100. However, the present disclosure is not limited thereto, and the information processing server 30 may include the information processing apparatus 100, and the processes associated with automatic model structure search and model compression may be performed on the information processing server 30, and only the GUI display may be performed on the information processing terminal 10. Further, it is sufficient if each of the processes performed by the above information processing apparatus 100 is performed by either the information processing terminal 10 or the information processing server 30 of the information processing system in FIG. 1.

### 4. Configuration Example of Computer

The above series of processes can be performed by hardware or software. In a case where the series of processes are performed by software, the program included in the software is installed to a computer incorporated in dedicated hardware, a general-purpose personal computer, or the like from a program recording medium.

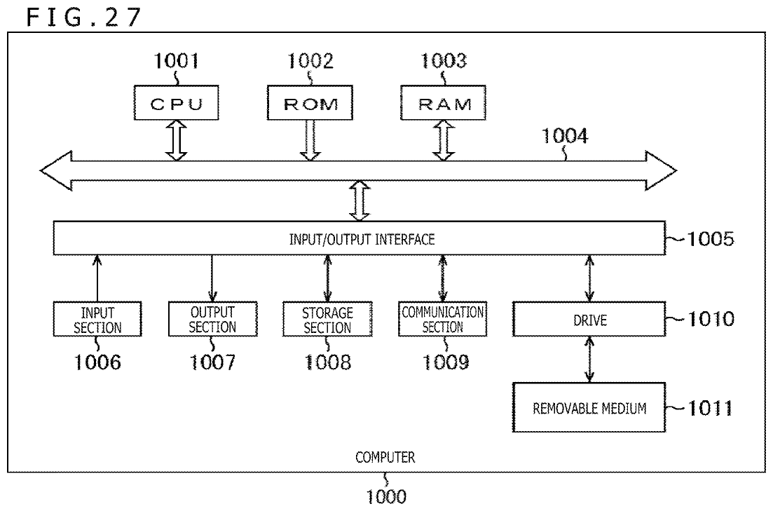

FIG. 27 is a block diagram illustrating a hardware configuration example of a computer that performs the above series of processes by a program.

The above information processing apparatus 100 is realized by a computer 1000 having a configuration illustrated in FIG. 27.

A CPU 1001, a ROM 1002, and a RAM 1003 are connected to each other by a bus 1004.

An input/output interface 1005 is further connected to the bus 1004. An input section 1006 that includes a keyboard, a mouse, and the like and an output section 1007 that includes a display, a speaker, and the like are connected to the input/output interface 1005. Also, a storage section 1008 that includes a hard disk, a non-volatile memory, and the like, a communication section 1009 that includes a network interface, and a drive 1010 that drives a removable medium 1011 are connected to the input/output interface 1005.

In the computer 1000 configured as described above, the above series of processes are performed, for example, as a result of loading and execution of a program stored in the storage section 1008 into the RAM 1003 via the input/output interface 1005 and the bus 1004 by the CPU 1001.

The program executed by the CPU 1001 is provided, for example, in a manner recorded on the removable medium 1011 or via a wired or wireless transmission medium such as a local area network, the Internet, or digital broadcasting and is installed to the storage section 1008.

It should be noted that the program executed by the computer 1000 may be a program that performs the processes chronologically according to the sequence described in the present specification or performs the processes in parallel or at a necessary timing such as when the program is invoked.

It should be noted that embodiments of the present technology are not limited to the embodiment described above and can be modified in various ways without departing from the gist of the present technology.

Also, the advantageous effects described in the present specification are merely illustrative and not restrictive, and there may be other advantageous effects.

Further, the present disclosure can have the following configurations.

(1)

An information processing method including:

by an information processing apparatus,

accepting selection of a task by a user;

acquiring input data used for learning of the task; and

displaying, as a default model, a neural network having a structure appropriate to the selected task and the acquired input data.

(2)

The information processing method of feature (1), further including:

displaying, as the default model, the neural network having a structure appropriate to not only the task and the input data but also hardware information of the information processing apparatus.

(3)

The information processing method of feature (2), in which

the hardware information includes information associated with a processor's processing capability.

(4)

The information processing method of feature (2), in which

the hardware information includes information associated with the number of processors.

(5)

The information processing method of any one of features (1) to (4), further including:

displaying at least one of a search space size and a calculation amount of the default model together with the default model.

(6)

The information processing method of any one of features (1) to (5), further including:

accepting a change of the default model by the user.

(7)

The information processing method of feature (6), further including:

accepting addition of a computation layer to the default model.

(8)

The information processing method of any one of features (1) to (7), further including:

preferentially displaying, as an option for a structure search technique of the neural network, the structure search technique appropriate to the task and the input data.

(9)

The information processing method of feature (8), further including:

preferentially displaying the structure search technique appropriate to not only the task and the input data but also hardware information of the information processing apparatus.

(10)

The information processing method of feature (8) or (9), further including:

accepting a setting input of the structure search technique selected by the user from among the options.

(11)

The information processing method of any one of features (8) to (10), further including:

displaying a predicted time required for structure search, according to the structure search technique selected by the user from among the options.

(12)

The information processing method of any one of features (8) to (11), further including:

performing structure search based on the structure search technique selected by the user from among the options; and

displaying the neural network having a structure searched for.

(13)

The information processing method of feature (12), in which

a computation layer selected by the user in the neural network is subject to structure search.

(14)

The information processing method of feature (12), in which

a cell included in the neural network is subject to structure search.

(15)

The information processing method of any one of features (1) to (14), further including:

further accepting selection of a compression technique of the neural network.

(16)

The information processing method of feature (15), further including:

accepting a setting of a compression condition for each index selected by the user for a computation layer of the neural network.

(17)

The information processing method of feature (16), further including:

compressing the neural network by the selected compression technique; and

displaying a compression result of the computation layer.

(18)

The information processing method of feature (17), further including:

displaying a compression rate of the computation layer for the index selected by the user.

(19)

An information processing apparatus including:

an acceptance section adapted to accept selection of a task by a user;

an acquisition section adapted to acquire input data used for learning of the task; and

a display control section adapted to display, as a default model, a neural network having a structure appropriate to the selected task and the acquired input data.

(20)

A program causing a computer to perform processes of:

accepting selection of a task by a user;

acquiring input data used for learning of the task; and

displaying, as a default model, a neural network having a structure appropriate to the selected task and the acquired input data.

### REFERENCE SIGNS LIST

10: Information processing terminal
30: Information processing server
100: Information processing apparatus
110: Control section
120: Input section
130: Display section
140: Communication section
150: Storage section
211: Acceptance section
212: Acquisition section
213: Decision section
214: Execution section
215: Display control section
1000: Computer

1. An information processing method comprising:
by an information processing apparatus,
accepting selection of a task by a user;
acquiring input data used for learning of the task; and
displaying, as a default model, a neural network having a structure appropriate to the selected task and the acquired input data.

2. The information processing method of claim 1, further comprising:
displaying, as the default model, the neural network having a structure appropriate to not only the task and the input data but also hardware information of the information processing apparatus.

3. The information processing method of claim 2, wherein
the hardware information includes information associated with a processor's processing capability.

4. The information processing method of claim 2, wherein
the hardware information includes information associated with the number of processors.

5. The information processing method of claim 1, further comprising:
displaying at least one of a search space size and a calculation amount of the default model together with the default model.

6. The information processing method of claim 1, further comprising:
accepting a change of the default model by the user.

7. The information processing method of claim 6, further comprising:
accepting addition of a computation layer to the default model.

8. The information processing method of claim 1, further comprising:
preferentially displaying, as an option for a structure search technique of the neural network, the structure search technique appropriate to the task and the input data.

9. The information processing method of claim 8, further comprising:
preferentially displaying the structure search technique appropriate to not only the task and the input data but also hardware information of the information processing apparatus.

10. The information processing method of claim 8, further comprising:
accepting a setting input of the structure search technique selected by the user from among the options.

11. The information processing method of claim 8, further comprising:
displaying a predicted time required for structure search, according to the structure search technique selected by the user from among the options.

12. The information processing method of claim 8, further comprising:
performing structure search based on the structure search technique selected by the user from among the options; and
displaying the neural network having a structure searched for.

13. The information processing method of claim 12, wherein
a computation layer selected by the user in the neural network is subject to structure search.

14. The information processing method of claim 12, wherein
a cell included in the neural network is subject to structure search.

15. The information processing method of claim 1, further comprising:
further accepting selection of a compression technique of the neural network.

16. The information processing method of claim 15, further comprising:
accepting a setting of a compression condition for each index selected by the user for a computation layer of the neural network.

17. The information processing method of claim 16, further comprising:
compressing the neural network by the selected compression technique; and
displaying a compression result of the computation layer.

18. The information processing method of claim 17, further comprising:
displaying a compression rate of the computation layer for the index selected by the user.

19. An information processing apparatus comprising:
an acceptance section adapted to accept selection of a task by a user;
an acquisition section adapted to acquire input data used for learning of the task; and
a display control section adapted to display, as a default model, a neural network having a structure appropriate to the selected task and the acquired input data.

20. A program causing a computer to perform processes of:
accepting selection of a task by a user;
acquiring input data used for learning of the task; and
displaying, as a default model, a neural network having a structure appropriate to the selected task and the acquired input data.
